(19) United States
(12) Patent Application Publication
(10) Pub. No.: US 2026/0201610 A1
(43) Pub. Date: Jul. 16, 2026

(54) ALGAL CELLULOSE FIBER

(71) Applicant: UNIVERSITY OF TECHNOLOGY SYDNEY, Ultimo, New South Wales (AU)

(72) Inventors: Peter RALPH, Ultimo, New South Wales (AU); Unnikrishnan KUZHIUMPARAMBIL, Ultimo, New South Wales (AU); Nandhini RAVI, Ultimo, New South Wales (AU); Parijat RAY, Ultimo, New South Wales (AU)

(21) Appl. No.: 19/137,321

(22) PCT Filed: Dec. 13, 2023
(86) PCT No.: PCT/AU2023/051291

§ 371 Date: Jun. 10, 2025

(30) Foreign Application Priority Data
Dec. 14, 2022 (AU) 2022903825

(51) Int. Cl. D01F 2/04; C08B 16/00

(52) U.S. Cl. CPC D01F 2/04; C08B 16/00

(57) ABSTRACT

The present disclosure relates to a fiber comprising regenerated cellulose, wherein the cellulose is obtained from an algae, and a method of making thereof.

The present application claims priority to Australian Provisional Patent Application No. 2022903825 filed 14 Dec. 2022, the entire disclosure of which is incorporated herein by cross-reference.

### FIELD OF THE DISCLOSURE

The present disclosure broadly relates to fibers and textiles prepared from algal cellulose.

### BACKGROUND OF THE DISCLOSURE

Any discussion of the prior art throughout this specification should in no way be considered as an admission that such prior art is widely known or forms part of the common general knowledge in the field.

Natural cotton consists of staple fibers of highly crystalline cellulose, which can be mechanically processed into a fabric or yarn.

Cotton is used extensively in the global apparel industry, with cotton products constituting about 20% of the market. It is a popular material due to its relatively low cost, comfort, and durability.

However, there are significant environmental issues associated with cotton use. Cotton is a highly water-intensive crop, with some estimates putting the amount of water required to produce a single cotton shirt at about 2700 L. Cotton is also the world's single largest pesticide consuming crop.

It would be desirable to provide fibers, yarns and/or fabrics having comparable properties to cotton, but utilising a source of cellulose which can be obtained in an environmentally sustainable manner.

Algae has many advantages over cotton as a source of cellulose, such as a higher growth yield per area, ability to be grown in non-arable or arid regions, and ability to grow in non-freshwater environments. It is thus a sustainable alternative to cultivation of cotton.

### SUMMARY OF THE DISCLOSURE

In a first aspect of the disclosure, there is provided a fiber comprising regenerated cellulose, wherein the cellulose is obtained from an algae.

The following options may be used in conjunction with the first aspect of the disclosure, either individually or in any combination.

Cellulose obtained from an algae may comprise at least about 50% w/w of the fiber. The fiber may consist of regenerated cellulose, and wherein the cellulose is obtained solely from an algae.

The fiber may be a filament fiber. Alternatively, the fiber may be a staple fiber.

The algae may be an algae of the genus Chaetomorpha.

The fiber may have a diameter of between about 100 and 500 μm. The fiber may have a diameter of between about 200 and about 300 μm.

In a second aspect of the disclosure, there is provided a yarn comprising the fiber of the first aspect of the disclosure.

The following options may be used in conjunction with the second aspect of the disclosure, either individually or in any combination.

The yarn may have a yarn count of between about 5 tex and about 50 tex.

In a third aspect of the disclosure, there is provided a method of producing a fiber comprising regenerated cellulose obtained from an algae, the method comprising:
(i) extracting cellulose from the algae;
(ii) dissolving the cellulose in a solvent to form a dope solution; and
(iii) extruding the dope solution into an anti-solvent to produce the fiber.

The following options may be used in conjunction with the third aspect of the disclosure, either individually or in any combination.

The algae may be an algae of the genus Chaetomorpha.

Step (i) may comprise treating the algae with an aqueous base solution.

Step (i) may be followed by a step (i.a.) of hydrolysing the cellulose with an aqueous acid solution at elevated temperature to provide hydrolysed cellulose. Step (i.a.) may further comprise neutralising the hydrolysed cellulose.

Step (i) may be followed by a step (i.b.) of removing water from the cellulose.

The solvent may be selected from the group consisting of an ionic liquid, carbon disulfide, N-methylmorpholine N-oxide, and cuprammonium solution. The solvent may be an ionic liquid. The ionic liquid may consist of an imidazolium, pyridinium, guanidinium or ammonium cation and a halide or an acetate anion. The ionic liquid may be selected from the group consisting of 1-ethyl-3-methylimidazolium acetate, 1-butyl-3-methylimidazolium chloride, 1-N-allyl-3-methylimidazolium chloride, 7-methyl-1,5,7-triazabicyclo[4.4.0]dec-5-enium acetate ([mTBDH][OAc]), N,N,N,N-tetramethylguanidium acetate, and 1,5-diaza-bicyclo[4.3.0]non-5-enium acetate ([DBNH][OAc]). The solvent may be 1-ethyl-3-methylimidazolium acetate.

The cellulose concentration of the dope solution may be between about 2% w/w and about 15% w/w. The cellulose concentration of the dope solution may be between about 5% w/w and about 12% w/w.

Step (ii) may further comprise heating the cellulose in the solvent.

Step (iii) may comprise dry-jet wet-spinning. Alternatively, step (iii) may comprise wet-spinning.

The anti-solvent may be selected from the group consisting of water, methanol, ethanol, and a mixture of two or more thereof. The anti-solvent may be ethanol.

The method may further comprise a step (iv) of drying the fiber.

In a fourth aspect of the disclosure, there is provided a fiber prepared by the method of the third aspect of the disclosure.

The following options may be used in conjunction with the first or fourth aspects of the disclosure, either individually or in any combination.

The fiber may have a load bearing capacity of at least about 30 g.

The fiber may have a breaking load of at least about 30 g.

The fiber may have a breaking force of at least about 0.2 N at a testing speed of 50 mm/min.

The fiber may have a breaking tenacity of at least about 0.2 cN/tex at a testing speed of 50 mm/min.

The fiber may have an elongation of at least about 8% at a testing speed of 50 mm/min.

In a fifth aspect of the disclosure, there is provided a fabric woven or knitted from the fiber of the first or fourth aspects of the disclosure, or from the yarn of the second aspect of the disclosure.

The following options may be used in conjunction with the fifth aspect of the disclosure, either individually or in any combination.

The fiber of the first or fourth aspects of the disclosure or the yarn of the second aspect of the disclosure may comprise at least 50% w/w of the fabric. The fabric may be woven or knitted solely from the fiber of the first or fourth aspects of the disclosure or from the yarn of the second aspect of the disclosure.

The fabric may comprise at least 50% w/w of cellulose obtained from an algae.

### Definitions

The following are some definitions that may be helpful in understanding the description of the present disclosure. These are intended as general definitions and should in no way limit the scope of the present disclosure to those terms alone, but are put forth for a better understanding of the following description.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The terms “a” and “an” are used herein to refer to one or to more than one (i.e. to at least one) of the grammatical object of the article. By way of example, “an element” means one element or more than one element.

In the context of this specification the term “about” is understood to refer to +10% of the recited value.

Any numerical range recited herein is intended to include all sub-ranges of the same numerical precision subsumed within the recited range. For example, a range of 1.0 to 5.0 is intended to include all sub-ranges between (and including) the recited minimum value of 1.0 and the recited maximum value of 5.0, that is, having a minimum value equal to or greater than 1.0 and a maximum value equal to or less than 5.0, such as 2.1 to 4.5. Any maximum numerical limitation recited herein is intended to include all lower numerical limitations subsumed therein and any minimum numerical limitation recited herein is intended to include all higher numerical limitations subsumed therein.

Any description of prior art documents herein, or statements herein derived from or based on those documents, is not an admission that the documents or derived statements are part of the common general knowledge of the relevant art.

For the purposes of description, all documents referred to herein are hereby incorporated by reference in their entirety unless otherwise stated.

### BRIEF DESCRIPTION OF THE DRAWINGS

FIG. 1. Spinning of dope solution of cellulose obtained from Chaetomorpha algae using syringe and syringe pump.

FIG. 2. Filament fiber prepared by spinning of dope solution of cellulose obtained from Chaetomorpha algae using syringe and syringe pump.

FIG. 3. Electron micrograph of filament fiber obtained by spinning of dope solution of cellulose obtained from Chaetomorpha algae using syringe with 21G needle and syringe pump.

FIG. 4. Electron micrograph of filament fiber obtained by spinning of dope solution of cellulose obtained from Chaetomorpha algae using syringe with 22G needle and syringe pump.

FIG. 5. Thermogravimetric analysis of Oedogonium fiber (A), acid washed Chaetomorpha fiber (B), Chaetomorpha fiber (C), Oedogonium fiber from lactate (D), and acid washed Oedogonium fiber (E).

FIG. 6. Load bearing capacity determination of (a) filament fiber obtained by spinning of dope solution of cellulose obtained from Chaetomorpha algae using syringe with 21G needle (b) filament fiber obtained by spinning of dope solution of microcrystalline cellulose using syringe with 21G needle.

FIG. 7. Tensile strength determination of filament fiber obtained by spinning of dope solution of cellulose obtained from Chaetomorpha algae using syringe with 27G needle.

FIG. 8. Woven fabric prepared from Chaetomorpha cellulose fiber.

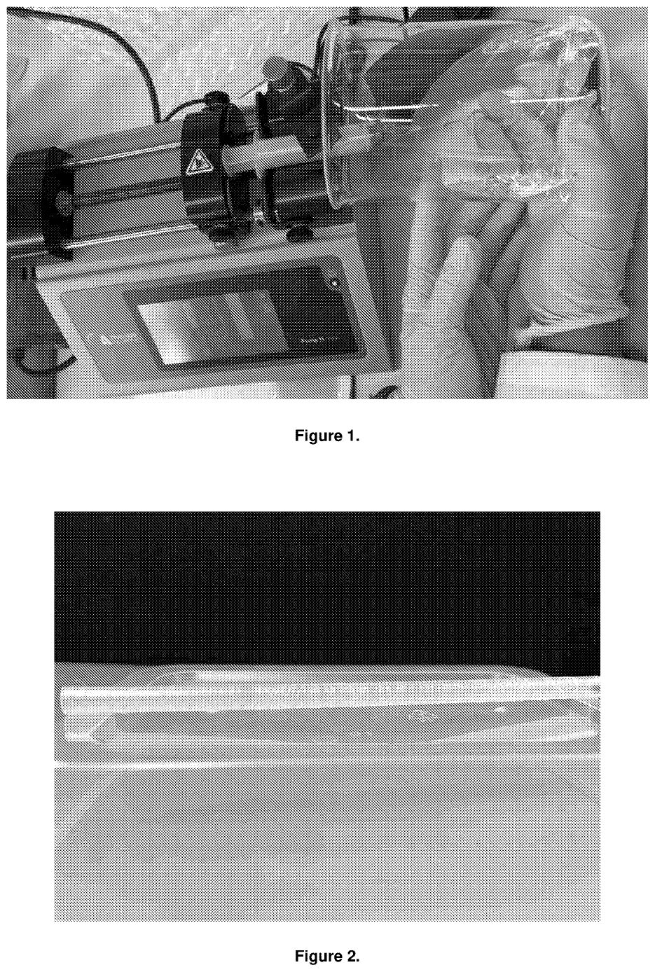

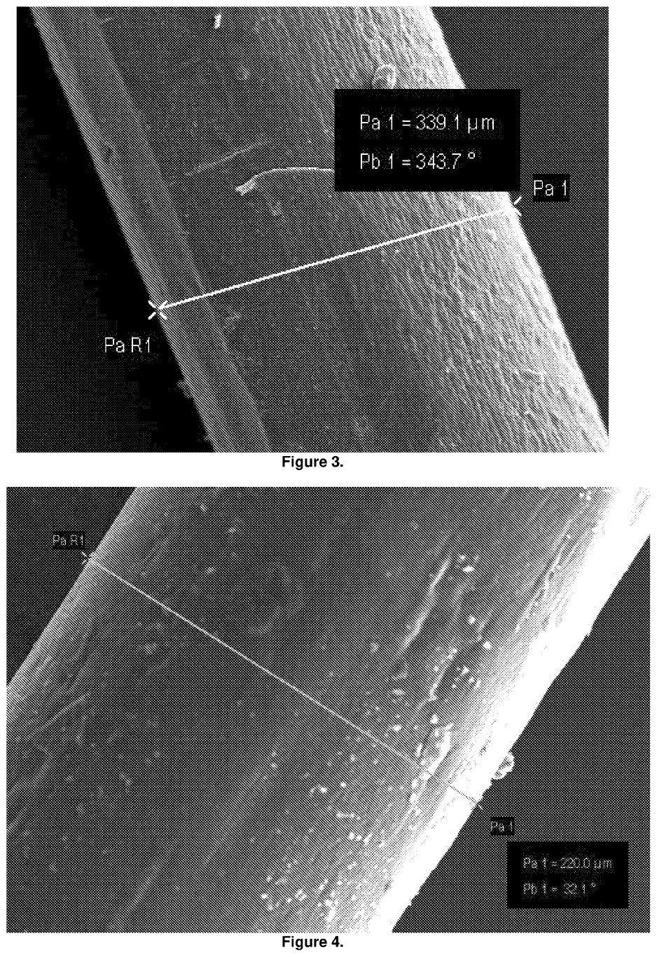

### DETAILED DESCRIPTION

The inventors have found that regenerated cellulose fibers, prepared from cellulose which is obtained from algae, can be used to prepare yarn and fabric which has useful properties, similarly to cotton. In particular, regenerated cellulose fibers, prepared from cellulose which is obtained from algae of the genus Chaetomorpha provide yarn and fabric having unexpectedly superior properties.

### An Algae-Derived Cellulose Fiber and Yarn

In a first aspect of the disclosure, there is provided a fiber comprising regenerated cellulose, wherein the cellulose is obtained from an algae. Regenerated cellulose refers to cellulose which has been dissolved in a solvent and then ‘regenerated’ (i.e. precipitated) into a desired form, such as a fiber. Naturally occurring cellulose is typically cellulose I, which comprises parallel strands of glucose units without intersheet hydrogen bonding. Regenerated cellulose is typically cellulose II, which is the more thermodynamically stable form, and comprises antiparallel strains of glucose units with intersheet hydrogen bonding.

The fiber of the first aspect of the disclosure comprises regenerated cellulose which is obtained from an algae. That is, the cellulose is extracted from algae, for example using the process described in relation to the third aspect of the disclosure. Algae are generally defined as aquatic photosynthetic eukaryotic organisms, which lack many of the cell and tissue types found in land plants, such as stomata, xylem and phloem. Algae include seaweeds and microalgae. Examples of algae include species of Chaetomorpha, Oedogonium, Cladaphora, Chlorella, and Scenedesmus. In some embodiments, the algae may be of the genus Chaetomorpha. In some embodiments, the algae may be of the genus Chaetomorpha or the genus Oedogonium. In some embodiments, the algae may be of the genus Oedogonium.

The fiber comprising regenerated cellulose of the first aspect of the disclosure may comprise at least about 50% w/w cellulose obtained from algae, or at least about 55, 60, 65, 70, 75, 80, 85, 90, 95, 96, 97, 98, or at least about 99% w/w cellulose obtained from algae. The fiber comprising regenerated cellulose of the first aspect of the disclosure may comprise about 50% w/w cellulose obtained from algae, or about 55, 60, 65, 70, 75, 80, 85, 90, 95, 96, 97, 98, or about 99% w/w cellulose obtained from algae. The fiber may consist of regenerated cellulose, wherein 100% w/w of the cellulose is obtained from algae. That is, the cellulose may be obtained solely from an algae. Put another way, the fiber may consist of cellulose obtained from an algae.

The fiber comprising regenerated cellulose of the first aspect of the disclosure may also comprise cellulose from a non-algal source, as well as cellulose obtained from algae. For example, the fiber may comprise cellulose obtained from wood pulp or cellulose obtained from bamboo. The fiber may comprise microcrystalline cellulose. The fiber comprising regenerated cellulose of the first aspect of the disclosure may comprise up to about 50% w/w cellulose obtained from a non-algal source, or up to about 5, 10, 15, 20, 25, 30, 35, 40, or up to about 45% cellulose obtained from a non-algal source. The fiber comprising regenerated cellulose of the first aspect of the disclosure may comprise about 50% w/w cellulose obtained from a non-algal source, or about 5, 10, 15, 20, 25, 30, 35, 40, or about 45% cellulose obtained from a non-algal source.

The fiber comprising regenerated cellulose of the first aspect of the disclosure may be a staple fiber. A staple fiber is a fiber having a discrete length. Alternatively, the fiber comprising regenerated cellulose of the first aspect of the disclosure may be a filament fiber. A filament fiber is a continuous fiber of indefinite length.

The fiber comprising regenerated cellulose of the first aspect of the disclosure may have a diameter of between about 100 μm and about 400 μm, or between about 100 and 200, 100 and 300, 200 and 300, 200 and 400, or between about 300 μm and 400 μm. The fiber comprising regenerated cellulose of the first aspect of the disclosure may have a diameter of about 100 μm, or about 150, 200, 250, 300, 350, or about 400 μm.

In a second aspect of the disclosure, there is a provided a yarn comprising the fiber of the first aspect of the disclosure. That is, the fiber comprising regenerated cellulose of the first aspect of the disclosure may be spun into a yarn. The yarn may be spun using conventional methods known to the skilled person. Where the fiber is a staple fiber the yarn may be a staple fiber yarn. Where the fiber is a filament fiber, the yarn may be a filament yarn. The yarn may be spun from a mixture of staple and filament fibers. The yarn may comprise at least 50% w/w of the fiber of the first aspect of the disclosure, or at least about 55, 60, 65, 70, 75, 80, 85, 90, 95, 96, 97, 98, or at least about 99% w/w of the fiber of the first aspect of the disclosure. The yarn may comprise 50% w/w of the fiber of the first aspect of the disclosure, or about 55, 60, 65, 70, 75, 80, 85, 90, 95, 96, 97, 98, or about 99% w/w of the fiber of the first aspect of the disclosure. The yarn may consist of the fiber of the first aspect of the disclosure, that is, it may comprise 100% w/w of the fiber of the first aspect of the disclosure.

The yarn of the second aspect of the disclosure may have a yarn count of between about 5 and about 50 tex, or between about 5 and 10, 5 and 20, 5 and 40, 5 and 40, 10 and 20, 10 and 30, 10 and 40, 10 and 50, 20 and 30, 20 and 40, 20 and 50, 30 and 40, 30 and 50, or between about 40 and about 50 tex. The yarn may have a yarn count of between about 10 and about 20 tex. The yarn may have a yarn count of between about 5 and about 20 tex. The yarn may have a yarn count of about 5 tex, or about 5, 10, 20, 30, 40 or about 50 tex.

### A Method of Making a Algae-Derived Cellulose Fiber

In a third aspect of the disclosure, there is provided a method of producing a fiber comprising regenerated cellulose obtained from an algae, the method comprising:
(i) extracting cellulose from the algae;
(ii) dissolving the cellulose in a solvent to form a dope solution; and
(iii) extruding the dope solution into an anti-solvent to produce the fiber.

The fiber comprising regenerated cellulose obtained from an algae that is produced in the method of the third aspect of the disclosure may be a fiber of the first aspect of the disclosure.

Step (i) of the method of the third aspect of the disclosure comprises extracting cellulose from an algae. The algae may be as described above in respect of the first aspect of the disclosure. In some embodiments, the algae may be an algae of the genus Chaetomorpha. In some embodiments, the algae may be an algae of the genus Chaetomorpha or of the genus Oedogonium. In some embodiments, the algae may be an algae of the genus Oedogonium. Prior to step (i), the algae may optionally be bleached. Step (i) may comprise treating the algae with an aqueous base solution. Following treatment with the aqueous base solution, the solids may be isolated, for example by centrifuging, to provide cellulose. The aqueous base solution may be any suitable strong base, such as an aqueous solution of sodium hydroxide. The aqueous base solution may have a concentration of about 1 to 10 M, or about 2 to 7 M, or about 5 M. The aqueous base solution may be 5 M aqueous sodium hydroxide.

In some embodiments, step (i) may be followed by step (i.a.) of hydrolysing the cellulose with an aqueous acid solution at elevated temperature to provide hydrolysed cellulose. Acid hydrolysis may improve the crystallinity of the resulting cellulose by removing amorphous cellulose. Acid hydrolysis also results in fibers having improved tensile strength and thermal stability compared to fibers prepared from cellulose which has not been subject to acid hydrolysis. The aqueous acid solution may be any suitable strong acid, such as an aqueous solution of hydrochloric acid. The aqueous acid solution may have a concentration of about 0.5 to 5 M, or about 2 to 3 M, or about 2.5 M. The aqueous acid solution may be 2.5 M aqueous hydrochloric acid. The hydrolysis may take place at an elevated temperature of between about 50° C. and about 100° C. The hydrolysis may take place at an elevated temperature of about 100° C. Following acid hydrolysis, the cellulose may be neutralised. That is, it may be washed with water and/or treated with a base such that it reaches approximately pH 7.

In some embodiments, step (i), and, if present, step (i.a.), may be followed by step (i.b.) of removing water from the cellulose. This may be done by any conventional technique known to the skilled person. For example, the cellulose may be centrifuged followed by freeze-drying.

In step (ii) of the third aspect of the disclosure, the cellulose extracted from the algae in step (i) is dissolved in a solvent to form a dope solution. The solubility of cellulose in various solvents is well known. The solvent may be selected from the group consisting of an ionic liquid, carbon disulfide, N-methylmorpholine N-oxide, and cuprammonium solution. Cuprammonium solution refers to an aqueous solution of the metal ammine complex [Cu(NH₃)₄(H₂O)₂](OH)₂, which is also known as Schweizer's reagent.

In some embodiments, dissolving the cellulose in the solvent may comprise heating the cellulose in the solvent. The cellulose in the solvent may be heated at a temperature of at least about 50° C., or between about 50° C. and about 100° C.

In some embodiments, the solvent may be an ionic liquid. Ionic liquids suitable for dissolving cellulose typically contain an imidazolium, pyridinium, guanidinium or ammonium cation, in combination with either a halide or an acetate anion. For example, the ionic liquid may be selected from the group consisting of 1-ethyl-3-methylimidazolium acetate, 1-butyl-3-methylimidazolium chloride, 1-N-allyl-3-methylimidazolium chloride, 7-methyl-1,5,7-triazabicyclo[4.4.0]dec-5-enium acetate ([mTBDH][OAc]), N, N,N, N-tetramethylguanidium acetate, and 1,5-diaza-bicyclo[4.3.0]non-5-enium acetate ([DBNH][OAc]). The ionic liquid, i.e. the solvent, may be 1-ethyl-3-methylimidazolium acetate.

The solution of dissolved cellulose in the solvent is referred to as the dope solution. The concentration of cellulose in the dope solution may be between about 2% w/w and about 15% w/w, or between about 2 and 3, 2 and 4, 2 and 5, 2 and 6, 2 and 7, 2 and 8, 2 and 9, 2 and 10, 2 and 11, 2 and 12, 2 and 13, 2 and 14, 3 and 4, 3 and 5, 3 and 6, 3 and 7, 3 and 8, 3 and 9, 3 and 10, 3 and 11, 3 and 12, 3 and 13, 3 and 14, 3 and 15, 4 and 5, 4 and 6, 4 and 7, 4 and 8, 4 and 9, 4 and 10, 4 and 11, 4 and 12, 4 and 13, 4 and 14, 4 and 15, 5 and 6, 5 and 7, 5 and 8, 5 and 9, 5 and 10, 5 and 11, 5 and 12, 5 and 13, 5 and 14, 5 and 15, 6 and 7, 6 and 8, 6 and 9, 6 and 10, 6 and 11, 6 and 12, 6 and 13, 6 and 14, 6 and 15, 7 and 8, 7 and 9, 7 and 10, 7 and 11, 7 and 12, 7 and 13, 7 and 14, 7 and 15, 8 and 9, 8 and 10, 8 and 11, 8 and 12, 8 and 13, 8 and 14, 8 and 15, 9 and 10, 9 and 11, 9 and 12, 9 and 13, 9 and 14, 9 and 15, 10 and 11, 10 and 12, 10 and 13, 10 and 14, 10 and 15, 11 and 12, 11 and 13, 11 and 14, 11 and 15, 12 and 13, 12 and 14, 12 and 15, 13 and 14, 13 and 15, or between about 14% w/w and about 15% w/w. The concentration of cellulose in the dope solution may be between about 5% w/w and about 12% w/w. The concentration of cellulose in the dope solution may be between about 4% w/w and about 7% w/w. The concentration of cellulose in the dope solution may be between about 5% w/w and about 7% w/w. The concentration of cellulose in the dope solution may be between about 5% w/w and about 6.5% w/w. The concentration of cellulose in the dope solution may be about 2% w/w, or about 3, 4, 5, 5.5, 6, 6.5, 7, 8, 9, 10, 11, 12, 13, 14, or about 15% w/W.

In step (iii) of the third aspect of the disclosure, the dope solution is extruded to form a fiber. The dope solution may be extruded directly into an anti-solvent in a wet-spinning process. Alternatively, the dope solution may be extruded into an air gap before passing into an anti-solvent in a dry-jet wet-spinning process. Anti-solvents for regenerating cellulose are well known. In some embodiments, the solvent may be a polar protic solvent. In some embodiments, the solvent may be selected from the group consisting of water, methanol, ethanol, and a mixture of two or more thereof. The anti-solvent may be ethanol. The extruded cellulose may be left in the anti-solvent for a period of time to enable phase separation to occur. The period of time may be between about 0.5 and about 5 hours, or between about 1 and 4 hours, or between about 2 and about 3 hours. The period of time may be between about 2 and about 3 hours. The period of time may be 1, 2, 3, 4, or 5 hours. The period of time may be 2 hours. The period of time may be 3 hours.

The method of the third aspect of the disclosure may comprise a step (iv) of drying the fiber comprising regenerated cellulose obtained from an algae. This may be carried out in any conventional manner. For example, the fiber may be dried in an oven at elevated temperature, such as 100° C.

In a fourth aspect of the disclosure there is provided a fiber prepared by the method of the third aspect of the disclosure.

### Properties of the Algae-Derived Cellulose Fiber

The fiber of the first or fourth aspect of the disclosure may have a load bearing capacity of at least about 30 g, or at least about 35, 40, 45, 50, 55 or about 60 g. The fiber of the first or fourth aspect of the disclosure may have a load bearing capacity of at least about 50 g. Load bearing capacity refers to the maximum weight that can be borne by the fiber before failure occurs.

The fiber of the first or fourth aspect of the disclosure may have a breaking load of at least about 30 g, or at least about 35, 40, 45, 50, 55 or about 60 g. The fiber of the first or fourth aspect of the disclosure may have a breaking load of at least about 50 g.

Load bearing capacity and breaking load are tested by suspending an incrementally increasing amount of weights from a fiber of about 30 mm length. The load at which the fiber breaks is the breaking load. The maximum load at which the weights could be suspended without breakage is the load bearing capacity.

The fiber of the first or fourth aspect of the disclosure may have a breaking force of at least about 0.2 N, or at least about 0.2, 0.3, 0.4, or 0.5 N, at a testing speed of 50 mm/min as measured according to ASTM D2256/D2256M-21. The fiber of the first or fourth aspect of the disclosure may have a breaking force of at least about 0.3 N at a testing speed of 50 mm/min. The fiber of the first or fourth aspect of the disclosure may have a breaking force of about 0.2 N, or about 0.2, 0.3, 0.4, or 0.5 N, at a testing speed of 50 mm/min. The fiber of the first or fourth aspect of the disclosure may have a breaking force of about 0.3 N at a testing speed of 50 mm/min.

The fiber of the first or fourth aspect of the disclosure may have a breaking tenacity of at least about 0.2 cN/tex, or at least about 0.2, 0.3, 0.4, or 0.5 cN/tex, at a testing speed of 50 mm/min. The fiber of the first or fourth aspect of the disclosure may have a breaking force of at least about 0.3 cN/tex at a testing speed of 50 mm/min. The fiber of the first or fourth aspect of the disclosure may have a breaking force of about 0.2 cN/tex, or about 0.2, 0.3, 0.4, or 0.5 cN/tex, at a testing speed of 50 mm/min. The fiber of the first or fourth aspect of the disclosure may have a breaking force of about 0.3 cN/tex at a testing speed of 50 mm/min. The breaking tenacity is defined as the breaking force (measured according to ASTM D2256/D2256M-21 as defined above) divided by the fineness of the fiber. The fineness is defined as the mass of 9000 m of the fiber.

The fiber of the first or fourth aspect of the disclosure may have an elongation of at least about 8%, or at least about 9, 10, 11, 12, 13, 14, or at least about 15% at a testing speed of 50 mm/min. The fiber of the first or fourth aspect of the disclosure may have an elongation of at least about 10% at a testing speed of 50 mm/min. The fiber of the first or fourth aspect of the disclosure may have an elongation of about 8%, or about 9, 10, 11, 12, 13, 14, or about 15% at a testing speed of 50 mm/min. The fiber of the first or fourth aspect of the disclosure may have an elongation of about 10% at a testing speed of 50 mm/min. To determine the elongation, the gage length prior to commencing breaking force testing according to ASTM D2256/D2256M-21 is noted, as well as the gage length at the conclusion of breaking force testing. The elongation is the gage length at the conclusion of testing divided by the gage length prior to commencing testing, expressed as a percentage.

### A Fabric of Algae-Derived Cellulose

In a fifth aspect of the disclosure there is provided a fabric which is woven or knitted from the fiber of the first or fourth aspects of the disclosure, or from the yarn of the second aspect of the disclosure. The fabric may be a woven fabric. The fiber of the first or fourth aspects of the disclosure, or the yarn of the second aspect of the disclosure may comprise at least 50% w/w of the fabric, or at least 60, 70, 80, 90, or 95% w/w of the fabric. The fiber of the first or fourth aspects of the disclosure, or the yarn of the second aspect of the disclosure may comprise 100% w/w of the fabric, that is, the fabric may be woven or knitted solely from the fiber of the first or fourth aspects of the disclosure, or the yarn of the second aspect of the disclosure. The fabric may comprise at least 50% w/w of cellulose obtained from an algae. The fabric may comprise at least 60, 70, 80, 90, or 95% w/w of cellulose obtained from an algae. The fabric may comprise 100% w/w of cellulose obtained from an algae, that is, the fabric may consist of cellulose derived from an algae.

The present disclosure may be described by reference to the following numbered embodiments.
1. A fiber comprising regenerated cellulose, wherein the cellulose is obtained from an algae.
2. The fiber of form 1, wherein cellulose obtained from an algae comprises at least about 50% w/w of the fiber.
3. The fiber of form 1 or form 2, wherein the fiber consists of regenerated cellulose, and wherein the cellulose is obtained solely from an algae.
4. The fiber of any one of forms 1 to 3, wherein the fiber is a filament fiber.
5. The fiber of any one of forms 1 to 3, wherein the fiber is a staple fiber.
6. The fiber according to any one of forms 1 to 5, wherein the algae is an algae of the genus Chaetomorpha.
7. The fiber according to any one of forms 1 to 6, wherein the fiber has a diameter of between about 100 and 500 μm.
8. The fiber according to any one of forms 1 to 7, wherein the fiber has a diameter of between about 200 and about 300 μm.
9. A yarn comprising the fiber of any one forms 1 to 8.
10. The yarn according to form 9, wherein the yarn has a yarn count of between about 5 and about 50 tex.
11. A method of producing a fiber comprising regenerated cellulose obtained from an algae, the method comprising:
(i) extracting cellulose from the algae;
(ii) dissolving the cellulose in a solvent to form a dope solution; and
(iii) extruding the dope solution into an anti-solvent to produce the fiber.
12. The method of form 11, wherein the algae is an algae of the genus Chaetomorpha.
13. The method of form 11 or form 12, wherein step (i) comprises treating the algae with an aqueous base solution.
14. The method of any one of forms 11 to 13, wherein step (i) is followed by a step (i.a.) of hydrolysing the cellulose with an aqueous acid solution at elevated temperature to provide hydrolysed cellulose.
15. The method of form 14, wherein step (i.a.) further comprises neutralising the hydrolysed cellulose.
16. The method of any one of forms 11 to 15, wherein step (i) is followed by a step (i.b.) of removing water from the cellulose.
17. The method of any one of forms 11 to 16, wherein the solvent is selected from the group consisting of an ionic liquid, carbon disulfide, N-methylmorpholine N-oxide, and cuprammonium solution.
18. The method of any one of forms 11 to 17, wherein the solvent is an ionic liquid.
19. The method of form 17 or form 18, wherein the ionic liquid consists of an imidazolium, pyridinium, guanidinium or ammonium cation and a halide or an acetate anion.
20. The method of any one of forms 17 to 19, wherein the ionic liquid is selected from the group consisting of 1-ethyl-3-methylimidazolium acetate, 1-butyl-3-methylimidazolium chloride, 1-N-allyl-3-methylimidazolium chloride, 7-methyl-1,5,7-triazabicyclo[4.4.0]dec-5-enium acetate ([mTBDH][OAc]), N,N,N,N-tetramethylguanidium acetate, and 1,5-diaza-bicyclo[4.3.0]non-5-enium acetate ([DBNH][OAc]).
21. The method of any one of forms 11 to 20, wherein the solvent is 1-ethyl-3-methylimidazolium acetate.
22. The method of any one of forms 11 to 21, wherein the cellulose concentration of the dope solution is between about 2% w/w and about 15% w/w.
23. The method of any one of forms 11 to 22, wherein the cellulose concentration of the dope solution is between about 5% w/w and about 12% w/w.
24. The method of any one of forms 11 to 23, wherein step (ii) further comprises heating the cellulose in the solvent.
25. The method of any one of forms 11 to 24, wherein step (iii) comprises dry-jet wet-spinning.
26. The method of any one of forms 11 to 24, wherein step (iii) comprises wet-spinning.
27. The method of any one of forms 11 to 26, wherein the anti-solvent is selected from the group consisting of water, methanol, ethanol, and a mixture of two or more thereof.
28. The method of any one of forms 11 to 27, wherein the anti-solvent is ethanol.
29. The method of any one of forms 11 to 28, further comprising a step (iv) of drying the fiber.
30. A fiber prepared by the method of any one of forms 11 to 29.
31. The fiber of any one of forms 1 to 9 or form 30, wherein the fiber has a load bearing capacity of at least about 30 g.
32. The fiber of any one of forms 1 to 9, 30 or 31, wherein the fiber has a breaking load of at least about 30 g.
33. The fiber of any one of forms 1 to 9, or 30 to 32, wherein the fiber has a breaking force of at least about 0.2 N at a testing speed of 50 mm/min.
34. The fiber of any one of forms 1 to 9, or 30 to 33, wherein the fiber has a breaking tenacity of at least about 0.2 cN/tex at a testing speed of 50 mm/min.
35. The fiber of any one of forms 1 to 9, or 30 to 34, wherein the fiber has an elongation of at least about 8% at a testing speed of 50 mm/min.
36. A fabric woven or knitted from the fiber of any one of forms 1 to 9 or 30 to 35, or from the yarn of form 10.
37. The fabric of form 36, wherein the fiber of any one of forms 1 to 9 or 30 to 35 or the yarn of form 10 comprises at least 50% w/w of the fabric.
38. The fabric of form 36 or form 37, wherein the fabric is woven or knitted solely from the fiber of any one of forms 1 to 9 or 30 to 35 or from the yarn of form 10.
39. The fabric of any one of forms 36 to 38, wherein the fabric comprises at least 50% w/w of cellulose obtained from an algae.

### EXAMPLES

The present disclosure is further described below by reference to the following non-limiting examples.

### Method 1—Extraction of Cellulose

Algae was washed and rinsed, then dried at 60° C. overnight and cut into small pieces. The algae pieces were placed in pH 3-4 solution (adjusted with acetic acid) then treated with 1% w/w sodium hypochlorite. The solution was centrifuged, supernatant discarded, then the residue filtered and dispersed in water. The dispersion of bleached algae was heated at 130° C. with stirring for 3-4 hours, then centrifuged, supernatant discarded, then the residue filtered and dispersed in water. The dispersion of bleached algae was then treated with NaOH solution (5 M) to provide cellulose (20-35% yield). The cellulose was treated with HCl solution (2.5 M, 20 parts HCl solution: 1 part cellulose) at 100° C. for 30 minutes. The resulting acid hydrolysed cellulose was neutralised, centrifuged, then freeze dried.

### Method 2—Preparation and Spinning of Dope Solution

Cellulose obtained according to Method 1 was dissolved in 1-ethyl-3-methylimidazolium acetate to a concentration of about 5-12% at 100° C. with stirring. The dope solution was taken up in a syringe, and extruded directly into a beaker of ethanol (wet spinning) through a needle using a syringe pump (varying needle gauges used: 21G, 22G, 27G). The resulting filament was left to stand in the ethanol was 2-3 hours, then dried in an oven at 100° C. for 1 hour.

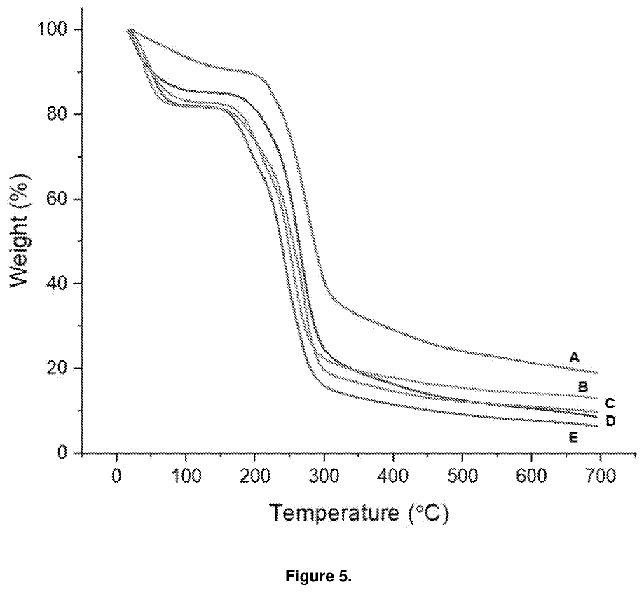

Cellulose was extracted and dope solution prepared according to Methods 1 and 2 from 12 varieties of algae: Ulva lactuca, Rhizoclonium, Ecklonia radiata, Eucheuma denticulatum, Kappaphycus alvarezii, Asparogopsis, Oedogonium, Spirulina, Scenedesmus, Phaedactylum, Chlorella vulgaris and Chaetomorpha. Only fiber prepared from cellulose obtained from Chaetomorpha provided a continuous fiber with consistent length on extrusion. Fibers prepared from cellulose obtained from other algal species provided only short strands which disintegrated easily and were not suitable for testing procedures. However TGA analysis of Oedogonium fibre showed good thermal stability compared Chaetomorpha fibre (FIG. 5).

A fiber of microcrystalline cellulose (Sigma Aldrich) and a fiber of a 50:50 blend of microcrystalline cellulose and Chaetomorpha-derived cellulose (obtained according to Method 1) were also prepared according to Method 2.

### Method 3—Testing of Algal Cellulose Filament

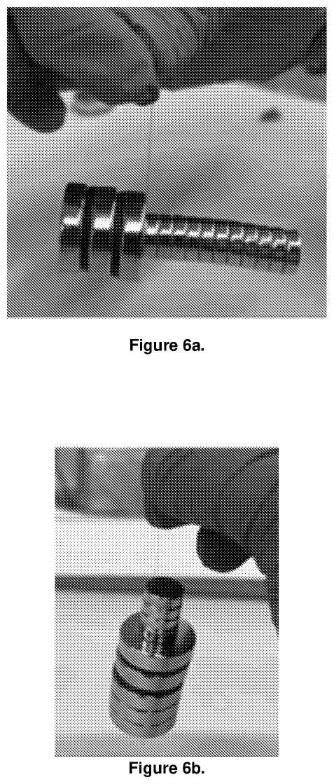

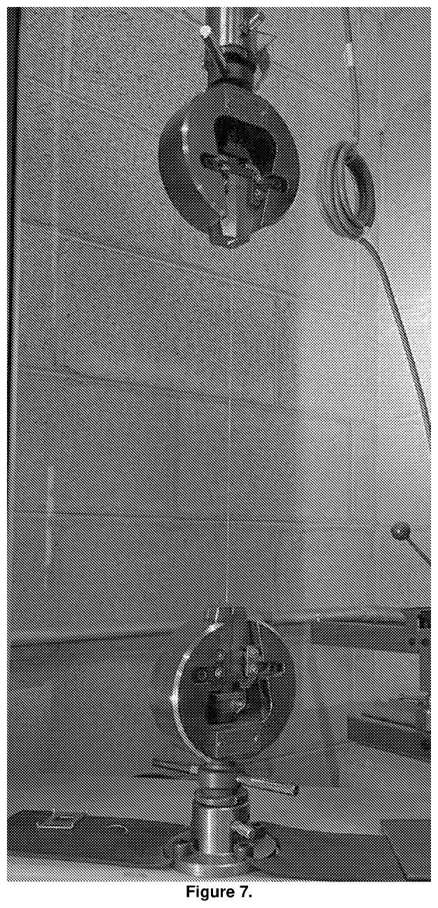

Fibers prepared from Chaetomorpha cellulose according to Methods 1 and 2 were tested for their load bearing capacity using magnetised weights. A fiber of about 30 mm length was suspended with the incremental addition of magnetised weights (see FIG. 6). The load at which the fiber broke was noted as the breaking load, and the load which the fiber withstood without breakage was noted as the load bearing capacity. Results are shown in Table 1.

TABLE 1
Load bearing capacity of regenerated Chaetomorpha cellulose
fibers extruded using needle of different gauge size.

| | Average Load Bearing | |
|---|---|---|
| Gauge size | Capacity (g) | Average Breaking load (g) |
| 21G | 127.36 ± 3.82 | 131.52 ± 2.67 |
| 22G | 60.69 ± 4.41 | 64.33 ± 4.04 |
| 27G | 28.29 ± 0.74 | 30.77 ± 0.52 |

The load bearing capacity of regenerated Chaetomorpha cellulose fibers prepared with and without an acid hydrolysis step were compared and the results shown in Table 2.

TABLE 2
Comparison of regenerated Chaetomorpha cellulose fibers
prepared with and without an acid hydrolysis step.

| | Load Bearing | Breaking |
|---|---|---|
| Treatment | Capacity (g) | load (g) |
| Fiber from cellulose obtained after acid | 127.36 | 131.52 |
| hydrolysis (21G needle) | | |
| Fiber from cellulose obtained after acid | 60.69 | 64.33 |
| hydrolysis (22G needle) | | |
| Fiber from cellulose without acid hydrolysis | 70.82 | 73.85 |
| (21G needle) | | |
| Fiber from cellulose without acid hydrolysis | 19.15 | 23.02 |
| (22G needle) | | |

Fibers prepared from Chaetomorpha cellulose according to Methods 1 and 2 were tested for their tensile properties using a Shimadzu AGS-X Test Machine with 500 N load cell, according to ASTM D2256/D2256M-21 (see FIG. 7). As per the ASTM standard, the gage length was maintained at 250±3 mm, tested at a rate of 50 mm/min on a CRE (Constant Rate of Extension) tension testing machine. A pre-tension of 5±0.1 cN/tex was maintained to remove any slack or kinks from the fiber without appreciable stretching.

The gage length prior to commencing breaking force testing according to ASTM D2256/D2256M-21 was noted, as well as the gage length at the conclusion of breaking force testing. The elongation is defined as the gage length at the conclusion of testing divided by the gage length prior to commencing testing, expressed as a percentage.

Fibers have a high length to diameter ratio. When comparing the tensile properties of different fibers, it is important to remove the effect on breaking load of the fineness of the fiber. The fineness is defined as mass per 9,000 metres of the fiber, expressed in units of tex. A known length of the fiber, e.g. 80 mm was taken and weighed to calculate the mass per 9,000 metres of the fiber. The resulting value is the fineness of the fiber. The breaking force obtained from tensile testing was divided by the fineness of the fiber to obtain the tenacity of the fiber. Results of tensile and elongation testing are shown in Table 3.

TABLE 3
Results of tensile and elongation testing for regenerated
Chaetomorpha cellulose fibers extruded using needle
of different gauge size and testing speed of 50 mm/min.

| Gauge size | Fineness (tex) | Tenacity (cN/tex) | Elongation (%) |
|---|---|---|---|
| 21G | 107.86 ± 0.32* | 1.19 ± 1.12* | 5.68 ± 0.78 |
| 22G | 98.56 ± 0.45* | 0.64 ± 0.89* | 4.75 ± 0.67* |
| 27G | 4.818 ± 0.711 | 2.8 ± 0.61 | 4.43 ± 1.53 |

*Extrapolated value.

TABLE 4
Results of tensile and elongation testing for regenerated Chaetomorpha cellulose
fibers compared with microcrystalline cellulose (MCC) and MCC blend fibers.

| | Testing Speed | Breaking | Breaking | Tenacity | Elongation |
|---|---|---|---|---|---|
| Fiber | (mm/min) | force (N) | load (g) | (cN/tex) | (%) |
| MCC | 300 | 0.82 | 83.55878 | 1.75 | 4.35 |
| MCC | 100 | 0.59 | 60.09003 | 1.26 | 1.56 |
| MCC | 100 | 0.68 | 69.36894 | 1.46 | 11.71 |
| Fiber from Chaetomorpha | 100 | 0.37 | 37.84496 | 0.34 | 12.88 |
| cellulose obtained after acid | | | | | |
| hydrolysis | | | | | |
| Fiber from Chaetomorpha | 50 | 0.086 | 8.76 | 2.8 ± 0.61 | 4.43 ± 1.53 |
| cellulose obtained after acid | | | | | |
| hydrolysis* | | | | | |
| MCC:Chaetomorpha 50:50 | 80 | 0.31 | 31.30516 | 0.28 | 13.07 |
| blend | | | | | |
| MCC:Chaetomorpha 50:50 | 50 | 0.2 | 20.39 | 2.28 ± 0.46 | 4.1 ± 1.6 |
| blend* | | | | | |

Fibers extruded using 21G gauge needle, except those marked with an asterisk (*) which were obtained with a 27G gauge needle.

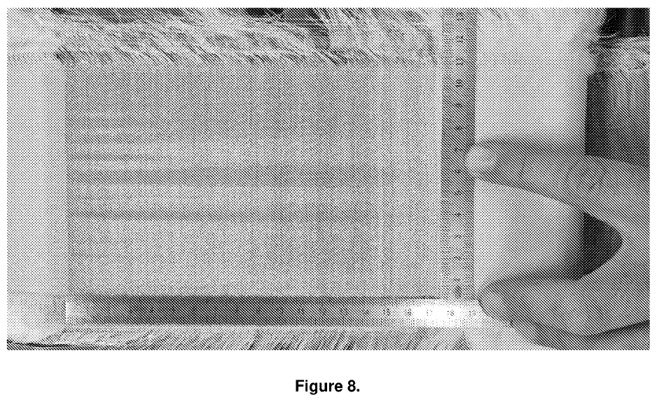

Fibers prepared from Chaetomorpha cellulose could be processed on an industrial loom to prepare a woven fabric (FIG. 8).

Those skilled in the art will appreciate that the disclosure described herein is susceptible to variations and modifications other than those specifically described. It is to be understood that the disclosure includes all such variations and modifications. The disclosure also includes all of the steps, features, compositions and compounds referred to or indicated in this specification, individually or collectively, and any and all combinations of two or more of said steps, features, compositions and compounds.

1. A fiber comprising regenerated cellulose, wherein the cellulose is obtained from an algae.

2. The fiber of claim 1, wherein cellulose obtained from an algae comprises at least about 50% w/w of the fiber.

3. The fiber of claim 2, wherein the fiber consists of regenerated cellulose, and wherein the cellulose is obtained solely from an algae.

4-5. (canceled)

6. The fiber according to claim 1, wherein the algae is an algae of the genus Chaetomorpha.

7. The fiber according to 1, wherein the fiber has a diameter of between about 100 and 500 μm.

8.-10. (canceled)

11. A method of producing a fiber comprising regenerated cellulose obtained from an algae, the method comprising:
(i) extracting cellulose from the algae;
(ii) dissolving the cellulose in a solvent to form a dope solution; and
(iii) extruding the dope solution into an anti-solvent to produce the fiber.

12. The method of claim 11, wherein the algae is an algae of the genus Chaetomorpha.

13. The method of claim 11, wherein step (i) comprises treating the algae with an aqueous base solution.

14. The method of claim 11, wherein step (i) is followed by a step (i.a.) of hydrolysing the cellulose with an aqueous acid solution at elevated temperature to provide hydrolysed cellulose.

15. The method of claim 14, wherein step (i.a.) further comprises neutralising the hydrolysed cellulose.

16. The method of claim 11, wherein step (i) is followed by a step (i.b.) of removing water from the cellulose.

17. The method of claim 11, wherein the solvent is selected from the group consisting of an ionic liquid, carbon disulfide, N-methylmorpholine N-oxide, and cuprammonium solution.

18. The method of claim 11, wherein the solvent is an ionic liquid.

19. (canceled)

20. The method of claim 17, wherein the ionic liquid is selected from the group consisting of 1-ethyl-3-methylimidazolium acetate, 1-butyl-3-methylimidazolium chloride, 1-N-allyl-3-methylimidazolium chloride, 7-methyl-1,5,7-triazabicyclo[4.4.0]dec-5-enium acetate ([mTBDH][OAc]), N,N,N,N-tetramethylguanidium acetate, and 1,5-diaza-bicyclo[4.3.0]non-5-enium acetate ([DBNH][OAc]).

21. (canceled)

22. The method of 11, wherein the cellulose concentration of the dope solution is between about 2% w/w and about 15% w/w.

23-24. (canceled)

25. The method of claim 11, wherein step (iii) comprises dry-jet wet-spinning.

26. The method of claim 11, wherein step (iii) comprises wet-spinning.

27. The method of claim 11, wherein the anti-solvent is selected from the group consisting of water, methanol, ethanol, and a mixture of two or more thereof.

28-35. (canceled)

36. A fabric woven or knitted from the fiber of claim 1.
